(19) United States
(12) Patent Application Publication
(10) Pub. No.: US 2023/0292412 A1
(43) Pub. Date: Sep. 14, 2023

(54) MICROWAVE OVEN WITH ACOUSTIC DETECTION

(71) Applicant: Winston Byrd, Norton, OH (US)

(72) Inventor: Winston Byrd, Norton, OH (US)

(21) Appl. No.: 17/691,575

(22) Filed: Mar. 10, 2022

(51) Int. Cl. H05B 6/64; H05B 6/68; H04R 1/02; G06F 3/16

(52) U.S. Cl. CPC H05B 6/6447; G06F 3/16; H04R 1/028; H05B 6/687

(57) ABSTRACT

A microphone within a microwave oven detects acoustic activity, and controls the generation of microwaves based on the acoustic activity. A popping rate of popcorn is determined based on acoustic activity. Sounds above a certain amplitude with a duration below a certain value are treated as a pop of a corn kernel. In embodiments, a noise cancellation process is employed to reduce background noise from sources such as fans and turntable motors. When multiple corn kernels pop within a predetermined duration, the multiple pop events can appear as a single pulse of increased amplitude in acquired audio data. By identifying the audio pulses of increased amplitude and treating those pulses as counting for more than one corn kernel pop, a more accurate popping rate may be determined, leading to more accurate microwave oven operation for producing popped corn from corn kernels.

### FIELD

The present invention relates generally to a microwave oven, and more particularly to a microwave oven with acoustic detection.

### BACKGROUND

The microwaves are reflected within the metal interior of the oven where they are absorbed by food. In a microwave oven, microwaves cause water molecules in food to vibrate, producing heat that cooks the food. The microwave energy is changed to heat as it is absorbed by food, thereby cooking the food. Microwaves can be produced inside the oven by a microwave generating source such as a magnetron. Microwave ovens can be used to cook a variety of different types of food in much less time than is required in a conventional oven. Furthermore, the small size of a microwave oven makes it a convenient appliance in kitchens, hotel rooms, college dorms, and other places.

### SUMMARY

Embodiments provide a microwave oven comprising: an enclosure; a cooking chamber disposed within the enclosure; a microwave generator, configured and disposed to transmit microwaves within the cooking chamber; a microphone, the microphone configured and disposed to detect popping of corn kernels within the cooking chamber; a processor, the processor disposed within the enclosure; and a memory, the memory disposed within the enclosure and coupled to the processor, wherein the memory contains instructions, which when executed by the processor, cause the processor to receive audio input from the microphone, and in response to the audio input, control output of the microwave generator.

Additional embodiments provide a microwave oven comprising: an enclosure; a cooking chamber disposed within the enclosure; a microwave generator, configured and disposed to transmit microwaves within the cooking chamber; a microphone, the microphone configured and disposed to detect popping of corn kernels within the cooking chamber; a processor, the processor disposed within the enclosure; a memory, the memory disposed within the enclosure and coupled to the processor, wherein the memory contains instructions, which when executed by the processor, cause the processor to: activate the microwave generator; receive audio input from the microphone, and in response to the audio input, control the operation of the microwave generator; compute a popping rate; a user interface, wherein the user interface is configured and disposed to render the popping rate.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity. Furthermore, for clarity, some reference numbers may be omitted in certain drawings.

FIG. 1 is a flowchart showing process steps for embodiments of the present invention.

FIG. 2 is a flowchart showing process steps for additional embodiments of the present invention.

FIG. 3 is a flowchart showing process steps for computing a popping rate.

FIG. 4A shows an exemplary audio input signal in accordance with embodiments of the present invention.

FIG. 4B shows an exemplary noise-reduced audio input signal in accordance with embodiments of the present invention.

FIG. 4C shows an exemplary noise-reduced audio input signal indicating peak identification in accordance with embodiments of the present invention.

FIG. 5 is a block diagram of a microwave oven in accordance with embodiments of the present invention.

### DETAILED DESCRIPTION

Disclosed embodiments provide acoustic detection for control of operation of microwave ovens. A microphone detects acoustic activity, and controls the generation of microwaves based on the acoustic activity. Disclosed embodiments are well-suited for preparing popcorn in a microwave oven. A popping rate is determined based on acoustic activity. Sounds above a certain amplitude with a duration below a certain value are treated as a pop of a corn kernel. The pop of a corn kernel represents a transition from a corn kernel to a piece of popped corn. In embodiments, the popping rate is computed and monitored during operation of the microwave oven. Once the popping rate exceeds a predetermined value, and then later falls below a second predetermined value, the cooking of the popcorn is considered to be complete, and the microwave generation source is deactivated. In some embodiments, a noise cancellation process is employed to reduce background noise from sources such as fans and turntable motors. This provides increased sensitivity for detecting pops over the operational noise of the microwave oven fan and turntable motor. Additional embodiments utilize a scaling factor to further refine the computation of the popping rate. When multiple corn kernels pop within a predetermined duration (e.g., less than four microseconds), the multiple pop events can appear as a single pulse of increased amplitude in acquired audio data. By identifying the audio pulses of increased amplitude and treating those pulses as counting for more than one corn kernel pop, a more accurate popping rate may be determined, leading to more accurate microwave oven operation for producing popped corn from corn kernels.

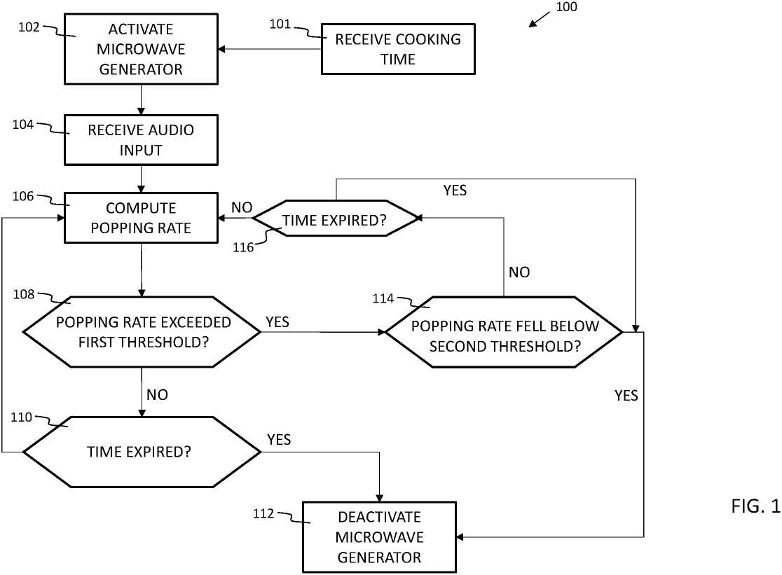

FIG. 1 is a flowchart 100 showing process steps for embodiments of the present invention. At 101, a cooking time is received. The time can be the cooking time entered by a user via a user interface of the microwave oven. For example, the entered time may be 180 seconds. At 102, a microwave generator, such as a magnetron, is activated, providing microwave energy into a cooking chamber of a microwave oven. A timer starts counting down from the cooking time entered (e.g., 180 seconds) at step 102. At 104, audio input is received. The audio input can be from a microphone placed in or near the cooking chamber. The audio input data acquired from the microphone is used to compute a popping rate at 106.

At 108 a check is made to determine if a popping rate has exceeded a first predetermined threshold during this operational cycle. An operational cycle starts when a user starts the microwave oven, and ends when the microwave generator is deactivated, either due to a timer expiry, or other reason. In embodiments, the first predetermined threshold ranges from 10 to 15 pops per second. In some embodiments, the first predetermined threshold ranges from 10 to 15 pops per second, and the second predetermined threshold range is 0.5 pops per second. If no at 108, the process continues to 110 where a check is made to determine if the cooking time expired. If at step 110, the time has expired, the process continues to 112 where the microwave generator is deactivated. Thus, the maximum cooking time is the time the user enters at step 101. However, based on acoustic data, the microwave oven may shut off (deactivate the microwave generator) earlier than the entered time. If at 110, the time did not expire, the process continues back to 106 where the popping rate is computed in real-time.

At 108, if yes, then the process continues to 114, where a check is made to see if a popping rate falls below a second predetermined threshold. In some embodiments, the second predetermined threshold ranges from one to five pops per second. In some embodiments, the second predetermined threshold ranges from zero to five pops per second. In some embodiments, the second predetermined threshold is one pop every two seconds, or 0.5 pops per second. If yes at 114, then the process continues to deactivate the microwave generator at 112. If no at 114, the process continues to 116 where a check is made to see if time has expired. If no at 116, then the process continues back to 106 where the popping rate is computed in real-time. Once the popping rate has exceeded the first threshold at some point during the cooking cycle, the flow proceeds back to 114 to determine if the popping rate falls below the second predetermined threshold.

If yes at 116, then embodiments may proceed to 112 to deactivate the microwave generator, thereby stopping the cooking of the contents of the microwave oven. In some embodiments, at 116, if time is expired, the cooking time may optionally be extended by a predetermined amount (e.g., ten seconds) to allow additional corn kernels to pop, before deactivating the microwave generator at step 112.

Embodiments can include a microwave oven comprising: an enclosure; a cooking chamber disposed within the enclosure; a microwave generator, configured and disposed to transmit microwaves within the cooking chamber; a microphone, the microphone configured and disposed to detect popping of corn kernels within the cooking chamber; a processor, the processor disposed within the enclosure; and a memory, the memory disposed within the enclosure and coupled to the processor, wherein the memory contains instructions, which when executed by the processor, cause the processor to receive audio input from the microphone, and in response to the audio input, control output of the microwave generator.

Embodiments include a computer memory comprising instructions, that when executed by the processor, cause the processor to: activate the microwave generator; compute a popping rate; and deactivate the microwave generator in response to the popping rate exceeding a first predetermined threshold, followed by falling below a second predetermined threshold.

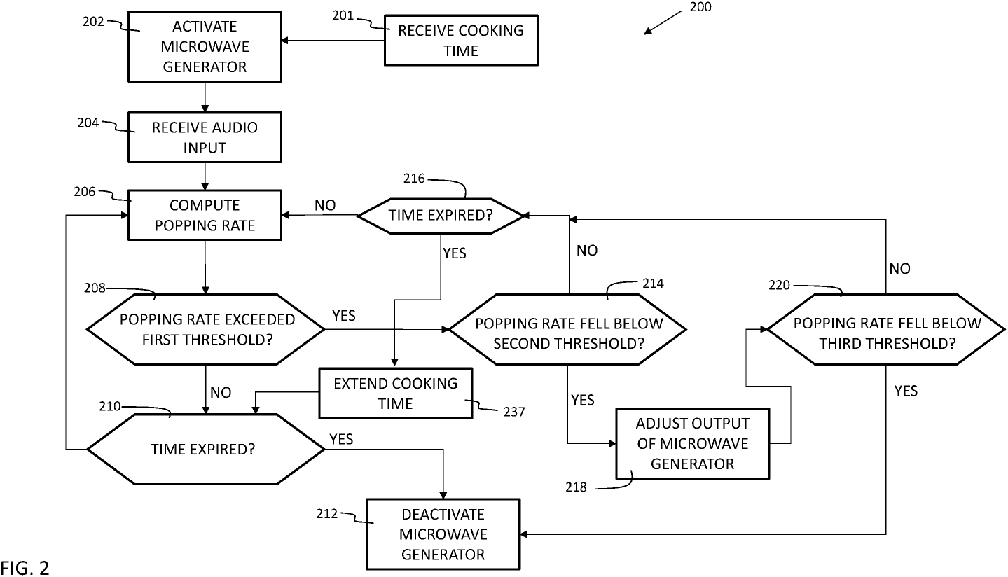

FIG. 2 is a flowchart 200 showing process steps for additional embodiments of the present invention. At 201, a cooking time is received. The time can be the cooking time entered by a user via a user interface of the microwave oven. For example, the entered time may be 180 seconds. At 202, a microwave generator, such as a magnetron, is activated, providing microwave energy into a cooking chamber of a microwave oven. A timer starts counting down from the cooking time entered (e.g., 180 seconds) at step 202. At 204, audio input is received. The audio input can be from a microphone placed in or near the cooking chamber. The audio input data acquired from the microphone is used to compute a popping rate at 206.

At 208 a check is made to determine if a popping rate has exceeded a first predetermined threshold during this operational cycle. In embodiments, the first predetermined threshold ranges from 10 to 15 pops per second. If no at 108, the process continues to 210 where a check is made to determine if the cooking time expired. If at step 210, the time has expired, the process continues to 212 where the microwave generator is deactivated. Thus, the maximum cooking time is the time the user enters at step 201. However, based on acoustic data, the microwave oven may shut off (deactivate the microwave generator) earlier than the entered time. If at 210, the time did not expire, the process continues back to 206 where the popping rate is computed in real-time.

At 208, if yes, then the process continues to 214, where a check is made to see if a popping rate falls below a second predetermined threshold. In some embodiments, the second predetermined threshold ranges from four to eight pops per second. If yes at 214, then the process continues to adjust output of the microwave generator at 218. In embodiments, the output is adjusted from 100 percent power to seventy percent power. This dual-stage power operation based on an acoustical signal allows some corn kernels to continue to pop while minimizing the risk of burning pieces of corn that have already popped. If no at 214, the process continues to 216 where a check is made to see if time has expired. If no at 216, then the process continues back to 206 where the popping rate is computed in real-time. Once the popping rate has exceeded the first threshold at some point during the cooking cycle, the flow proceeds back to 214 to determine if the popping rate falls below the second predetermined threshold. Once the popping rate falls below the second threshold the process continues to adjusting the output of the microwave generator, and then determining if the popping rate fell below a third predetermined threshold. In embodiments, the third predetermined threshold ranges from one to three pops per second. In some embodiments, the third predetermined threshold ranges from zero to three pops per second.

If yes at 220, then the process continues to 212 where the microwave generator is deactivated. If yes at 216 then the process continues to 237 where the cooking time is extended by a predetermined amount (e.g., ten seconds) to allow more corn kernels to pop while the popping rate is above the third predetermined threshold. After the extending of cooking time, the process continues to 210. Once time finally does expire, the process continues to 212 where the microwave generator is deactivated.

Embodiments include a computer memory comprising instructions, that when executed by the processor, cause the processor to: activate the microwave generator at a first output level; compute a popping rate; change output of the microwave generator to a second output level in response to the popping rate exceeding a first predetermined threshold, followed by falling below a second predetermined threshold; and deactivate the microwave generator in response to the popping rate exceeding a first predetermined threshold, followed by falling below a third predetermined threshold.

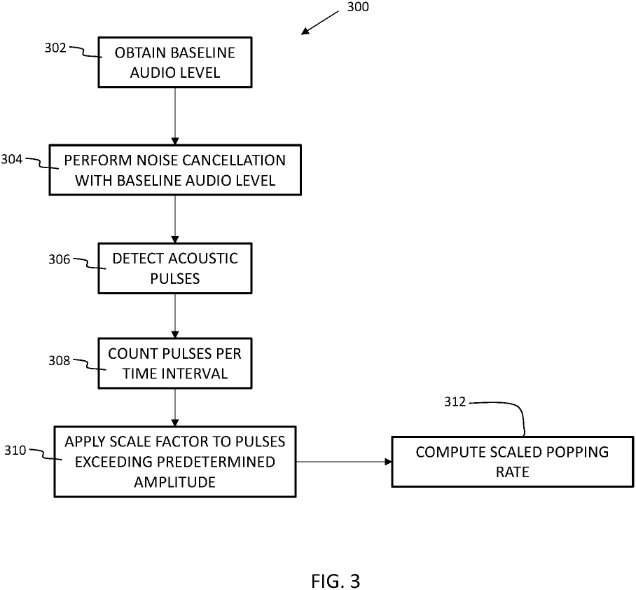

FIG. 3 is a flowchart 300 showing process steps for computing a popping rate. At 302 a baseline audio level is obtained. In embodiments, this may be an audio sample ranging in length from three to five seconds, that is acquired at the beginning of an operational cycle, before any corn kernels start to pop. Thus, the baseline audio level includes noise produced by other microwave oven elements such as any fans, and/or motors that operate a microwave turntable. At 304, a noise cancellation process is performed using the baseline audio level obtained at 302. In embodiments, the noise cancellation can be based on identifying the noise floor of the different frequencies that make up the baseline audio obtained at 302, and then subtracting and/or attenuating based on that baseline audio. This may create a cleaner audio signal for detecting pops.

At 306, acoustic pulses are detected. Acoustic pulses represent sounds having a duration below a predetermined value (e.g., 20 microseconds), and an amplitude above a predetermined value. These acoustic pulses may be treated as one or more corn kernel pop events. At 308 the number of pulses per a given time interval is counted. In embodiments, the time interval is one second, enabling a straightforward computation of a popping rate in pops per second.

At 310, a scale factor is applied to pulses exceeding a predetermined amplitude. A purpose of the scale factor is to improve accuracy in computing the popping rate. When corn kernels pop very close together in time, multiple pop events can appear as a single pulse of increased amplitude. Instead of treating these larger pulses as being associated with a single pop event, a scaling factor is applied to count the larger pulses as multiple pop events. As an example, with a scaling factor of two, each of the pulses exceeding a predetermined amplitude counts as two pop events. In some embodiments, there may be multiple scaling factors in use for different amplitudes. At 312, the scaled popping rate is computed by dividing the number of pops by the time duration to obtain a scaled popping rate which may be in units of pops per second.

Embodiments include a computer memory comprising instructions, that when executed by the processor, cause the processor to: obtain a baseline audio sample of operation of the microwave oven; and perform a noise cancellation process based on the baseline audio sample.

Embodiments include a computer memory comprising instructions, that when executed by the processor, cause the processor to: detect a plurality of amplitude peaks from the audio input; apply a scale factor for each peak from the plurality of peaks that exceeds a predetermined amplitude level; and adjust the popping rate based on the scale factor.

Embodiments include a computer memory comprising instructions, that when executed by the processor, cause the processor to: multiply each peak from the plurality of peaks that exceeds the predetermined amplitude level by the scale factor to obtain a scaled peak value for each peak; and wherein detecting the popping rate comprises adding the scaled peak value for each peak to a pop count value.

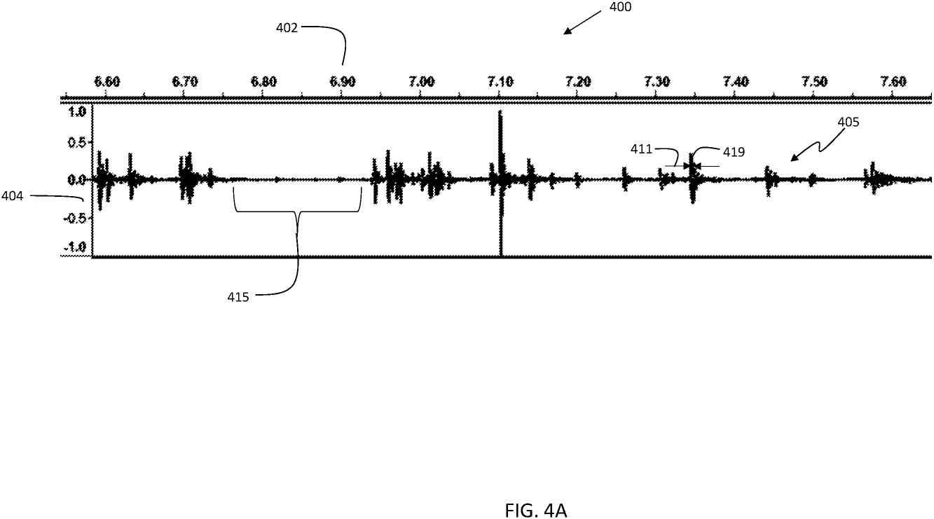

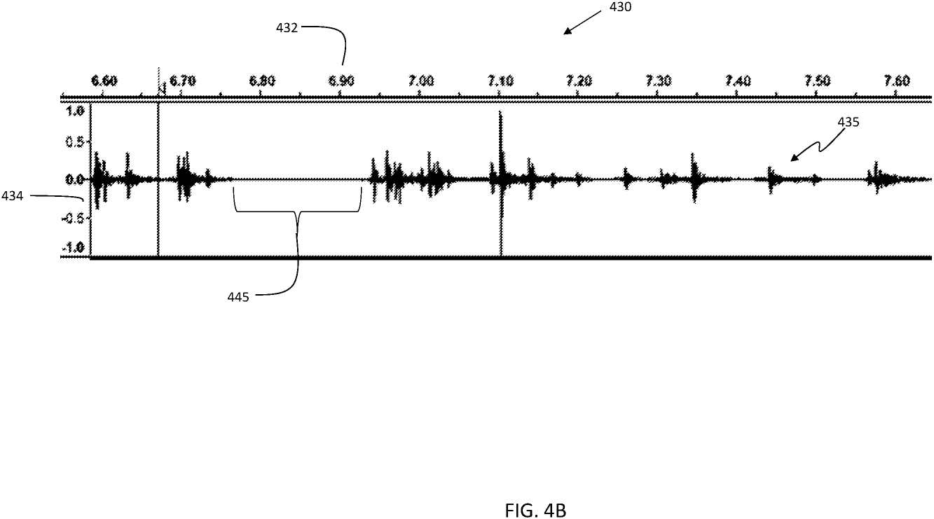

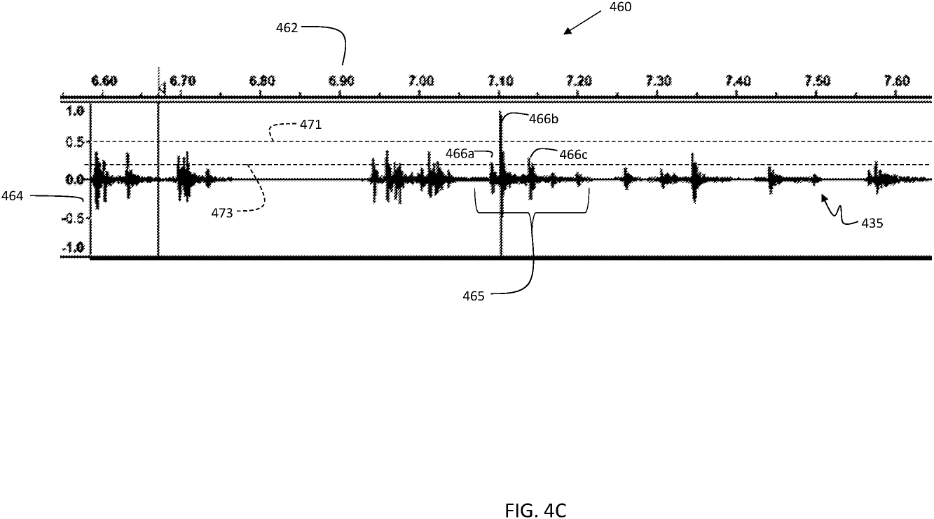

FIG. 4A shows an exemplary audio input signal in accordance with embodiments of the present invention. Graph 400 comprises a horizontal axis 402 showing time in seconds, and a vertical access 404 showing amplitude. The amplitude can be a normalized amplitude, or can be in an absolute scale in decibels or other suitable unit of measurement. Graph 400 includes audio signal 405. Region 415 of audio signal 405 includes a baseline audio level. Multiple pulses are shown, indicated generally as 419. Each pulse as a width 411 which represents a duration of the pulse. In embodiments, to be considered as a pulse that is associated with one or more pop events, the duration is below a predetermined threshold (e.g., 20 microseconds). Each pulse that meets these criteria may be considered as indicative of one or more pop events. A pop event is the transition of an unpopped corn kernel to a piece of popcorn due to heat generated by the microwave source.

FIG. 4B shows an exemplary noise-reduced audio input signal in accordance with embodiments of the present invention. Graph 430 comprises a horizontal axis 432 showing time in seconds, and a vertical access 434 showing amplitude. The amplitude can be a normalized amplitude, or can be in an absolute scale in decibels or other suitable unit of measurement. Graph 430 includes audio signal 435. Audio signal 435 is a noise-reduced version of audio signal 405 of FIG. 4A. In comparing region 415 of audio signal 435 with region 415 of audio signal 405 (FIG. 4A), it can be seen that there is less noise in the noise-reduced signal, as the region 445, as well as the rest of the audio signal 435 is smoothed as compared with the audio signal 405 of FIG. 4A.

Embodiments include a computer memory comprising instructions, that when executed by the processor, cause the processor to: obtain a baseline audio sample of operation of the microwave oven; and perform a noise cancellation process based on the baseline audio sample.

FIG. 4C shows an exemplary noise-reduced audio input signal indicating peak identification in accordance with embodiments of the present invention. Graph 460 comprises a horizontal axis 462 showing time in seconds, and a vertical access 464 showing amplitude. The amplitude can be a normalized amplitude, or can be in an absolute scale in decibels or other suitable unit of measurement. Graph 460 includes audio signal 435. Audio signal 435 is a noise-reduced version of audio signal 405 of FIG. 4A.

A first amplitude threshold is indicated at line 473. A second amplitude threshold is indicated at line 471. Region 465 shows an area of analysis for popping rate computation. Within region 465, three peaks, indicated as 466a, 466b, and 466c, exceed the level of the first amplitude threshold indicated by line 473. Peak 466b also exceeds the second amplitude threshold indicated by line 471. In computing a scaled popping rate, peak 466b is modified by the scale factor. As an example, if the scale factor has a value of 2, then peak 466b counts for two pop events. Thus, in region 465, the scaled pop count has a value of four, with one count for peak 466a, one count for peak 466c, and two counts for peak 466b. In this way, the scaled popping rate can account for pop events that occur nearly simultaneously, and do not produce distinct pulses. In some embodiments, after noise reduction, a compression process may be performed to further normalize the peaks to each other. Peaks that exceed the second amplitude threshold after compression may be deemed to represent multiple pop events and have a scale factor applied to them.

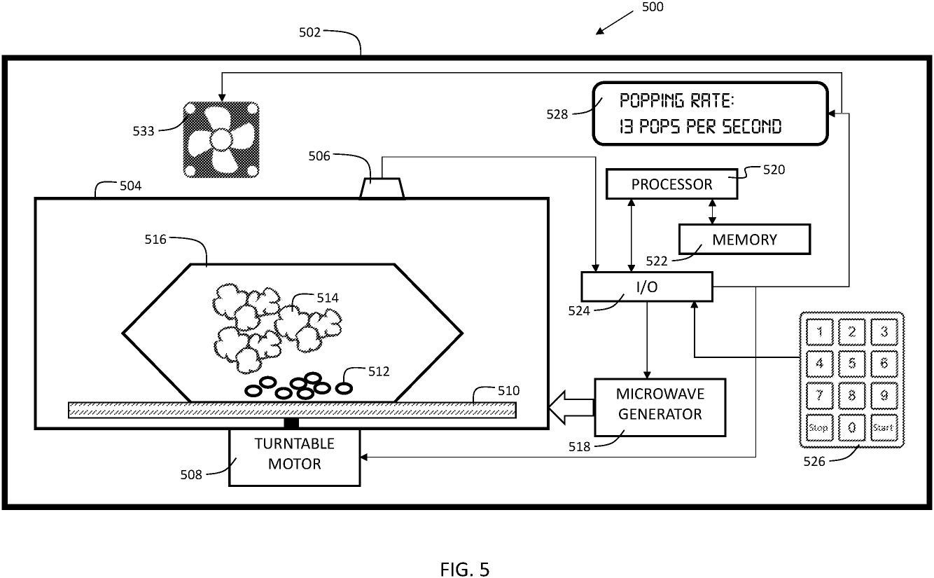

FIG. 5 is a block diagram of a microwave oven 500 in accordance with embodiments of the present invention. Microwave oven 500 comprises an enclosure 502. Within enclosure 502 is a cooking chamber 504. Within the cooking chamber there may be a turntable 510 which is rotated by a turntable motor 508.

During use, a user places a container 516 containing unpopped corn kernels, indicated generally as 512, into the cooking chamber 504. The user then starts an operational cycle by operating keypad 526, which activates the microwave generator 518. As heat is generated from microwaves originating from microwave generator 518, some of the corn kernels pop and become pieces of popcorn, indicated generally as 514. During the transition from corn kernel to a piece of popcorn, a brief sound is produced, which is detected by microphone 506. In embodiments, the microwave generator comprises a magnetron.

The microwave oven 500 includes a processor 520. Memory 522 is coupled to the processor 520, and contains machine instructions, that when executed by the processor 520, implement various features of disclosed embodiments. The memory 522 may be a non-transitory computer readable medium. Memory 522 may include RAM, ROM, flash, EEPROM, and/or other suitable storage technology.

The microwave oven 500 further includes an input/output (I/O) interface 524 which may include a plurality of input, output, and/or bidirectional pins. The processor 520 can access the I/O interface 524 to determine the state of input pins and/or set the state of output pins. The processor may implement one or more interrupt service routines in order to execute machine instructions in response to change in state of an input or bidirectional pin. The I/O interface 524 can control and/or receive feedback from various peripherals within the microwave oven 500. These include, but are not limited to, microphone 506, fan 533, microwave generator 518, turntable motor 508, keypad 526 and electronic display 528. The microphone 506 may be used to acquire audio data such as audio signal 405 shown in FIG. 4A. The audio data may be stored in memory 522 for further processing, including, but not limited to, noise-cancellation, compression, peak counting, and peak analysis.

The I/O interface 524 may be capable of receiving digital and/or analog signals. The keypad 526 and display 528 can comprise a user interface for the microwave oven 500. In embodiments, the user interface is configured and disposed to render a popping rate in real-time. In the example of FIG. 5, the popping rate is shown as 13 pops per second. In this way, a user can monitor the popping rate as the popcorn cooks. The rate rendered on display 528 can be a scaled popping rate in some embodiments. Display 528 is an electronic display. In embodiments, display 528 may be an LED (Light-emitting diode) display, LCD (liquid-crystal display), or other suitable display type. In embodiments, keypad 526 may be implemented in a touchscreen, or include membrane keys. The keypad 526 may include numbers 0 - 9, as well as a start and a stop button.

The processor 520 may receive audio signals such as depicted at 405 of FIG. 4A via microphone 506, and perform various operations such as noise-cancellation, compression, low-pass filtering, high-pass filtering, band-pass filtering, pulse identification, and/or other operations in order to determine a popping rate. Based on the popping rate, the processor 520 controls the output of the microwave generator 518 to enable an optimal corn popping operation that reduces waste of unpopped corn kernels while minimizing the risk of burnt popcorn.

Embodiments can include a microwave oven comprising: an enclosure; a cooking chamber disposed within the enclosure; a microwave generator, configured and disposed to transmit microwaves within the cooking chamber; a microphone, the microphone configured and disposed to detect popping of corn kernels within the cooking chamber; a processor, the processor disposed within the enclosure; a memory, the memory disposed within the enclosure and coupled to the processor, wherein the memory contains instructions, which when executed by the processor, cause the processor to: activate the microwave generator; compute a popping rate; receive audio input from the microphone, and in response to the audio input, control the operation of the microwave generator; a user interface, wherein the user interface is configured and disposed to render the popping rate.

As can now be appreciated, disclosed embodiments utilize acoustic data to determine an appropriate time to adjust and/or deactivate a microwave generator within a microwave oven. In this way, food such as popcorn is cooked an optimal amount, minimizing the amount of unpopped kernels while also minimizing burning of the popped kernels.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A microwave oven comprising:
an enclosure;
a cooking chamber disposed within the enclosure;
a microwave generator, configured and disposed to transmit microwaves within the cooking chamber;
a microphone, the microphone configured and disposed to detect popping of corn kernels within the cooking chamber;
a processor, the processor disposed within the enclosure; and
a memory, the memory disposed within the enclosure and coupled to the processor, wherein the memory contains instructions, which when executed by the processor, cause the processor to receive audio input from the microphone, and in response to the audio input, control output of the microwave generator.

2. The microwave oven of claim 1, wherein the microwave generator comprises a magnetron.

3. The microwave oven of claim 1, wherein the memory further comprises instructions, that when executed by the processor, cause the processor to:
activate the microwave generator;
compute a popping rate; and
deactivate the microwave generator in response to the popping rate exceeding a first predetermined threshold, followed by falling below a second predetermined threshold.

4. The microwave oven of claim 1, wherein the memory further comprises instructions, that when executed by the processor, cause the processor to:
activate the microwave generator at a first output level;
compute a popping rate;
change output of the microwave generator to a second output level in response to the popping rate exceeding a first predetermined threshold, followed by falling below a second predetermined threshold; and
deactivate the microwave generator in response to the popping rate exceeding a first predetermined threshold, followed by falling below a third predetermined threshold.

5. The microwave oven of claim 3, wherein the first predetermined threshold ranges from 10 to 15 pops per second, and the second predetermined threshold range is 0.5 pops per second.

6. The microwave oven of claim 4, wherein the first predetermined threshold ranges from 10 to 15 pops per second, the second predetermined threshold ranges from four to eight pops per second, and the third predetermined threshold ranges from one to three pops per second.

7. The microwave oven of claim 1, wherein the memory further comprises instructions, that when executed by the processor, cause the processor to:
obtain a baseline audio sample of operation of the microwave oven; and
perform a noise cancellation process based on the baseline audio sample.

8. The microwave oven of claim 3, wherein the memory further comprises instructions, that when executed by the processor, cause the processor to:
compute a plurality of peaks from the audio input;
apply a scale factor for each peak from the plurality of peaks that exceeds a predetermined amplitude level; and
adjust the computed popping rate based on the scale factor.

9. The microwave oven of claim 8, wherein the memory further comprises instructions, that when executed by the processor, cause the processor to:
multiply each peak from the plurality of peaks that exceeds the predetermined amplitude level by the scale factor to obtain a scaled peak value for each peak; and
wherein detecting the popping rate comprises adding the scaled peak value for each peak to a pop count value.

10. The microwave oven of claim 9, wherein the scale factor is two.

11. A microwave oven comprising:
an enclosure;
a cooking chamber disposed within the enclosure;
a microwave generator, configured and disposed to transmit microwaves within the cooking chamber;
a microphone, the microphone configured and disposed to detect popping of corn kernels within the cooking chamber;
a processor, the processor disposed within the enclosure;
a memory, the memory disposed within the enclosure and coupled to the processor, wherein the memory contains instructions, which when executed by the processor, cause the processor to:
activate the microwave generator;
receive audio input from the microphone, and in response to the audio input, control the operation of the microwave generator;
compute a popping rate;
a user interface, wherein the user interface is configured and disposed to render the popping rate.

12. The microwave oven of claim 11, wherein computing the popping rate is based on peaks within the audio input.

13. The microwave oven of claim 12, wherein the memory further comprises instructions, that when executed by the processor, cause the processor to:
deactivate the microwave generator in response to the popping rate exceeding a first predetermined threshold, followed by falling below a second predetermined threshold.

14. The microwave oven of claim 12, wherein the memory further comprises instructions, that when executed by the processor, cause the processor to:
activate the microwave generator at a first output level;
change output of the microwave generator to a second output level in response to the popping rate exceeding a first predetermined threshold, followed by falling below a second predetermined threshold; and
deactivate the microwave generator in response to the popping rate exceeding a first predetermined threshold, followed by falling below a third predetermined threshold.

15. The microwave oven of claim 13, wherein the first predetermined threshold ranges from 10 to 15 pops per second, and the second predetermined threshold ranges from one to five pops per second.

16. The microwave oven of claim 14, wherein the first predetermined threshold ranges from 10 to 15 pops per second, the second predetermined threshold ranges from four to eight pops per second, and the third predetermined threshold ranges from one to three pops per second.

17. The microwave oven of claim 11, wherein the memory further comprises instructions, that when executed by the processor, cause the processor to:
obtain a baseline audio sample of operation of the microwave oven; and
perform a noise cancellation process based on the baseline audio sample.

18. The microwave oven of claim 12, wherein the memory further comprises instructions, that when executed by the processor, cause the processor to:
detect a plurality of peaks from the audio input;
apply a scale factor for each peak from the plurality of peaks that exceeds a predetermined amplitude level; and
adjust the popping rate based on the scale factor.

19. The microwave oven of claim 18, wherein the memory further comprises instructions, that when executed by the processor, cause the processor to:
multiply each peak from the plurality of peaks that exceeds the predetermined amplitude level by the scale factor to obtain a scaled peak value for each peak; and
wherein detecting the popping rate comprises adding the scaled peak value for each peak to a pop count value.

20. The microwave oven of claim 19, wherein the scale factor is two.
